(19) United States
(12) Patent Application Publication
(10) Pub. No.: US 2012/0196174 A1
(43) Pub. Date: Aug. 2, 2012

(54) ELECTRICAL ENERGY STORAGE CELL AND CELL BLOCK, ELECTRICAL ENERGY STORAGE DEVICE AND THE VEHICLE COMPRISING THE SAME

(75) Inventors: Holger Mikus, Kamenz (DE); Andreas Fuchs, Leipzig (DE); Claus-Rupert Hohenthanner, Hanau (DE); Torsten Schmidt, Landsberg (DE); Mykola Polyakov, Kamenz (DE); Guenter Eichinger, Altenstadt (DE); Martin Schneider, Goeda (DE)

(73) Assignee: LI-TEC BATTERY GMBH, Kamenz (DE)

(21) Appl. No.: 13/254,092

(22) PCT Filed: Feb. 26, 2010
(86) PCT No.: PCT/EP2010/001218

§ 371 Date: Apr. 19, 2012

(30) Foreign Application Priority Data
Mar. 3, 2009 (DE) 10 2009 011 524.2

(51) Int. Cl. H01M 2/30; H01M 2/02; H01M 2/06

(52) U.S. Cl. 429/153; 429/178; 429/179

(57) ABSTRACT

An electrical energy storage cell is provided with: an active part which is equipped and adapted to store electrical energy supplied from the outside and to discharge stored electrical energy to the outside; at least two current conductors which are connected to the active part and are equipped and adapted to supply electric current from the outside to the active part and to discharge electric current from the active part to the outside; and an enclosure, which defines a prismatic basic shape having a substantially cuboid-like outline and encloses the active part in a gas-tight and fluid-tight manner. According to the invention, the enclosure has two flat foil parts and a peripheral seam part connecting the edges of the foil parts, wherein the seam part surrounds the active part in the manner of the frame and has sections of maximum thickness, in which the thickness is uniformly greater than the thickness of the active part. A cell block comprises a plurality of said electrical energy storage cells, wherein the cells are stacked in the direction of the thickness thereof and, together with connecting terminals, form an electrical energy storage device which can advantageously be used in a vehicle.

Priority application DE 10 2009 011 524.2 is fully incorporated by reference into the present application.

The present invention relates to an electrical energy storage cell and a cell block, consisting of a plurality of electrical energy storage cells connected to one another, an electrical energy storage device having a cell block, and to a vehicle equipped therewith.

Batteries (primary storage units) and accumulators (secondary storage units) for storing electric energy are known, which are composed of one or more storage cells in which, when a charging current is applied, in an electrochemical charging reaction between a cathode and an anode in or between an electrolyte, electrical energy is converted into chemical energy and therefore stored, and in which when an electrical load is applied chemical energy is converted into electrical energy in an electrochemical discharge reaction. Primary storage units are generally only charged up once and are to be disposed of after discharging, while secondary storage units allow multiple (from several 100 to more than 10000) cycles of charging and discharging. It is to be noted in this context that accumulators are sometimes referred to as batteries, for example vehicle batteries, which as is well known are subject to frequent charging cycles.

In recent years primary and secondary storage units based on lithium compounds have been increasing in importance. These have a high energy density and thermal stability, supply a constant voltage for a small self-discharge and are free from the so-called memory effect.

It is known to produce energy storage units and in particular lithium batteries and accumulators in the form of thin sheets. The paper “Primary and rechargeable lithium batteries” submitted to the Inorganic-chemical Technology Workshop at TU Graz by Dr. K.-C. Möller and Dr. M. Winter in February 2005 shows e.g. lithium-ion polymer cells in the format of a cheque card or even a smart-card. To refer to the functional principle of a lithium-ion cell this paper is used as an example. In such cells cathode and anode material, current collectors and separators in the form of thin foils are laid one on top of another (stacked) in a suitable manner and packed into a casing foil made of a made of a composite material, wherein current collectors which are connected to the current collector foils of the cathode or the anode respectively, project to the side from an edge of the cell.

By changing the number of anode and cathode pairs the capacitance of such a cell can be set as required, as is known for example from EP 1 475 852 A1. There, the ends of the current collector foils are collected together inside the casing foil and connected using connection means such as rivets, which extend perpendicularly through the casing foil, to a rod-shaped current collector placed on top of the casing foil. The externally placed current collectors then in turn project from an edge of the planar cell.

In EP 1 562 242 A2 a rod-shaped current collector separate from the ends of the current collector foils is also provided, but which is already connected to the ends of the current collector foils inside the casing foil and is again fed through the weld seam of the casing foil to the exterior. The rod-shaped current collectors thus project either from one edge or from opposite edges of the flat cell.

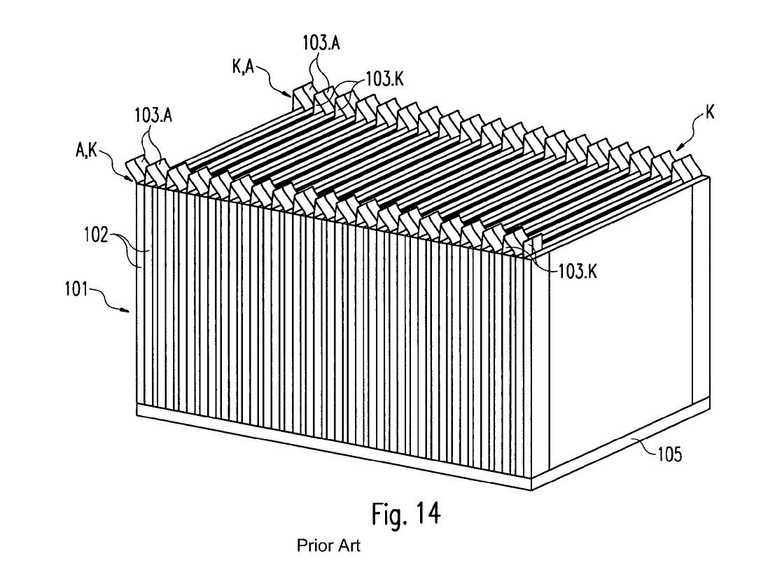

If on the other hand multiple flat cells are stacked to form a cell package, as is found for example in car batteries due to the higher voltages and capacitances regularly required there, then the individual parts are usually wired together on the top side, as is shown for example in WO 2008/128764 A1 or JP 07-282841 A. FIG. 14 shows an arrangement of multiple flat, parallelipipedal or plate-like single cells 102 according to WO 2008/128764 A1 in a cell stack 101. From anode A and cathode K of a cell 102, on opposing lateral sides a contact lug 103.A, 103.K respectively projects upwards on the same flat face from the same, upper edge (narrow face) of the cell. The cathode contact lug 103.K of each cell 102 is straight, while the anode contact lug 103.A of each cell 102 is bent, namely by approximately (probably somewhat more than) the thickness of each cell 102. In dem cell stack 101 in each case a cell 102, in which the anode A is arranged on the right and the cathode K on the left, follows a cell 102 in which the anode A is arranged on the left and the cathode K on the left. Thus, without further effort, in each case a (bent) anode contact lug 103.A comes into contact with a (straight) cathode contact lug 103.K, or at least in close proximity thereto, so that they can be connected together. A series circuit is thus realised. The cells 102 are arranged at a distance apart from one another and fixed onto a baseplate 105 with a force fit or positive fit.

The arrangement and attachment on the baseplate 105 requires careful alignment and reliable fixing. Disassembly of the cells requires individual detachment of the individual cells 102. Anchoring of the cells is only provided in the lower region, so that under the impact of accelerations or vibrations the connection points, which due to the inertia and elasticity of the cells 102 are formed between contact lugs in the upper area, can be exposed to mechanical stresses, which is made worse if the fixing to the baseplate 105 is only slightly loose. The contact surface of the contact lugs 103.A, 103.K is relatively small.

From an as yet unpublished development it is also known to combine multiple thin, parallelipipedal galvanic cells to form one or more stacks in such a manner that their sides of greatest extent are facing or touching each another, and are thus cast in a retaining device. Such an arrangement cannot be subsequently disassembled.

The inventors are also aware of an arrangement that is not documented in print in further detail, in which multiple flat cells are stacked between two end plates, wherein the stacks are held together by means of tensioning rods (threaded bolts) which extend between the end plates. In this arrangement, not inconsiderable pressure is exerted on the active part of the storage cells in the internal region.

It is an object of the present invention therefore to create a flat electrical energy storage device and a cell block consisting of multiple such cells, which offer an alternative to known construction types and in particular avoid the disadvantages of these construction types.

It is in particular an object of the invention to construct a flat electrical energy storage device such that when forming a block, a secure fixing of the position of the cells relative to one another is possible.

A further object of the invention is to construct a flat electrical energy storage device such that a block formed therefrom is as compact as possible, without the active regions being exposed to pressure-related stress.

The object is achieved by the features of the independent claims 1 and 25. Advantageous extensions of the invention form the subject matter of the dependent claims.

An electrical energy storage cell of the present invention has an active part which is equipped and adapted to store electrical energy supplied from the outside and to discharge stored electrical energy to the outside; at least two current conductors which are connected to the active part and are equipped and adapted to supply electric current from the outside to the active part and to discharge electric current from the active part to the outside; and an enclosure, which describes a prismatic basic shape having a substantially cuboid-like outline and encloses the active part in a gas-tight and fluid-tight manner. The enclosure has two laminar foil parts and a peripheral seam part connecting the edges of the foil parts, wherein the seam part surrounds the active part in the manner of the frame and has sections of maximum thickness, in which the thickness is uniformly greater than the thickness of the active part even under mechanical pressure.

Such a construction enables electrical energy storage cells (hereafter “cells” for short) to be stacked such that they rest against each other at the sections of maximum thickness of the seam part, without any mechanical impact being exerted on the active part. With suitable choice of material for the foil parts and the seam part and of the connection method between the foil parts and the seam part it is also possible to screen the active part against the effects of electromagnetic fields and to design the enclosure to be resistant to substances present and/or generated in the active part.

Preferably, the two foil parts, at least in the sections of maximum thickness, rest on opposing flat faces of the seam part in a planar manner and are connected tightly thereto. This guarantees that the foil parts are braced in two parallel planes and therefore form flat faces of the basic prismatic shape.

In a cell block formed from such cells the cells are stacked in the direction of their thickness and rest on top of one another, preferably at least in regions which correspond to the regions of maximum thickness of the seam part. The cells are also preferably clamped together in the stacking direction under pressure. A compact and secure arrangement and assembly of the individual cells is thus possible, without pressure being exerted on the active part of the respective cell.

Preferably, the seam part has through holes extending in the thickness direction in sections of maximum thickness and the foil parts have holes aligned with the through holes. In a cell block constructed from such cells the clamping of the cells can be effected by means of tensioning rods which extend through the through holes of all cells. A particularly simple and compact structure of the cell block is thus facilitated, since the volume occupied by the cells is used for the clamping. The cells are fixed together in a positionally stable manner at least by means of friction. Via the tensioning rods in combination with the through holes, the cells can be centred perpendicular to the stacking direction, before the cells are clamped together. This simplifies the installation and prevents clamping occurring during the assembly.

Particularly preferably, sleeves are provided which each extend into the through holes over part of the length of these and which project from one side of the seam part, wherein preferably the excess length of the sleeves and the remaining free length in the through holes are greater than the combined thickness of the foils and less than half the maximum thickness of the seam part plus the thickness of one of the foils. When assembling such cells to form a cell block, each part of a sleeve protruding from a cell extends into the remaining free part of a through hole of the seam part of an adjacent cell. This means that a centring of the cells relative to one another perpendicular to the stacking direction is already obtained during the assembly, before the tensioning rods are inserted and tightened. The tensioning rods extend through the sleeves and thus undergo reliable guiding.

Alternatively, the seam part can have elevations projecting in the thickness direction, wherein on the respectively opposite side of an elevation, an indentation is provided that matches the elevation in shape and size and is aligned therewith in the thickness direction, and the foil parts with the elevations or indentations have aligned holes of corresponding shape and extension, wherein preferably the height of the elevations and the depth of the indentations are greater than the combined thickness of the foils and less than half the maximum thickness of the seam part plus the thickness of one of the foils. When assembling such cells to form a cell block the one elevation of the seam part of a cell extends in each case into an indentation of the seam part of an adjacent cell. When assembling the cells a centring is thus obtained perpendicular to the stacking direction.

In addition to the elevations and indentations, the seam part can have through holes extending in the thickness direction in sections of maximum thickness and the foil parts can have holes aligned with the through holes, wherein the through holes are preferably centrally aligned with the elevations or indentations respectively. This allows a clamping of multiple cells to form a cell block in the above described manner to be achieved in a reliable, space-saving and simple manner, by having the tensioning rods extend through the through holes.

The current collectors of the cells preferably have a flat profile and project beyond the enclosure. With flat-profiled, projecting current collectors it is particularly simple to provide through-contacting of the cells within a cell block in a manner whereby a current collector of a cell is connected to a current collector of an adjacent cell and, if the cell is not the first or last cell of the cell block, the other current collector of the cell is connected to a current collector of another adjacent cell.

If current collectors of different polarity are always connected together, this results in a particularly simple means of implementing a series connection of the cells in the cell block.

The current collectors preferably project parallel to the flat faces of the basic prismatic shape defined by the enclosure and particularly preferably extend along and bound opposing flat faces of the basic prismatic shape defined by the enclosure. If such cells are combined or stacked in a cell block, these are preferably arranged such that current collectors are always opposite one another on the flat face which they bound, in the stacking direction of the cell block. As a result the current collectors of adjacent cells to be connected always lie opposite one another with the smallest axial separation and can be easily brought into contact with one another by means of clips or other means.

The current collectors can project from opposing narrow faces of the basic prismatic shape defined by the enclosure, or alternatively from the same narrow face. In addition, the prismatic structure can have four narrow faces of equal length, i.e. have a square construction in a section transverse to the stacking direction or to the corner direction, or two opposing pairs of narrow faces of different length, wherein the current collectors project from the longer pair or from the shorter pair of narrow faces. The final choice is determined by the installation conditions; the preferred being currently that the current collectors project from opposing narrow faces of the basic prismatic shape defined by the enclosure and from the longer pair of narrow faces.

Preferably the extension of the first and second current collector along the narrow faces from which they project is greater than half the length of said narrow faces. This means that the contact surface between current collectors is particularly large and hence the contact resistance advantageously small.

Particularly preferably, the current collectors each extend between the seam part and one of the foils, and are connected tightly thereto. Thus, electrodes arranged within the active part of the cell can be connected to the current collector and so sealing problems with through-contacted, external current collectors can be avoided.

Particularly preferably the current collectors have an L-shaped profile, one leg of which rests on a narrow face of the active part and the other leg of which extends through and between the seam part and one of the foils. The L-profile defines and stabilises the narrow face of the active part, and so this narrow face can rest against the inside of the frame shape of the seam part without affecting the active part.

If the seam part additionally has notches matched in size and shape to the current collectors, this guarantees a smooth external contour for the flat faces.

The present invention can be applied particularly preferably, but not exclusively to galvanic cells, in particular galvanic secondary cells of the flat type, in which the active part consists of a laminated foil packet of chemically active materials of two types, electrically conducting materials and separation layers, possibly soaked in an electrolyte material. The chemically active material of the at least one type preferably contains a lithium compound, and the chemically active material of the other type preferably contains graphite. Particularly preferably, the active part is evacuated, in order to prevent undesired reactions.

If a free current collector of the first cell in a cell block is connected to a connection pole and a free current collector of the last cell in the cell block is connected to another connection pole, the cell block is advantageously usable as an electrical energy storage device.

Particularly advantageously, such an electrical energy storage device is used in a vehicle.

The above named and additional features, objects and advantages of the present invention will be more clearly understood from the following description which has been prepared with reference to the attached drawings.

They show:

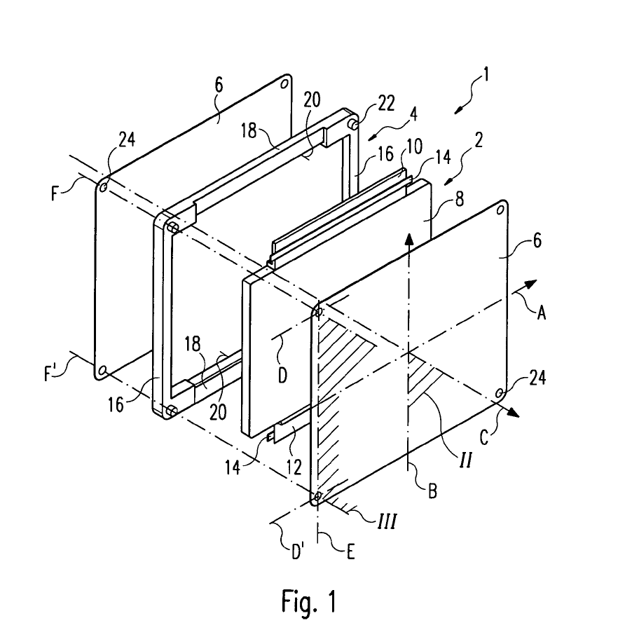

FIG. 1 a perspective exploded view of individual parts and assemblies respectively of a galvanic cell according to one embodiment of the present invention;

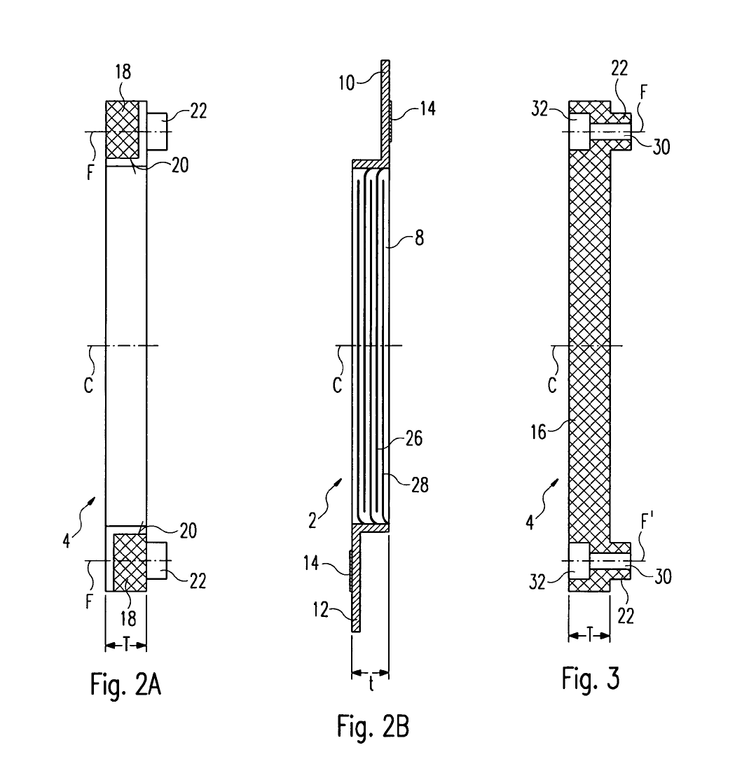

FIG. 2A a section of a frame part along a plane II in FIG. 1;

FIG. 2B a section of an active part along the plane II in FIG. 1;

FIG. 3A a section of the frame part along a plane III in FIG. 1;

FIG. 4 a perspective view of a galvanic cell according to a second embodiment of the present invention in the assembled condition;

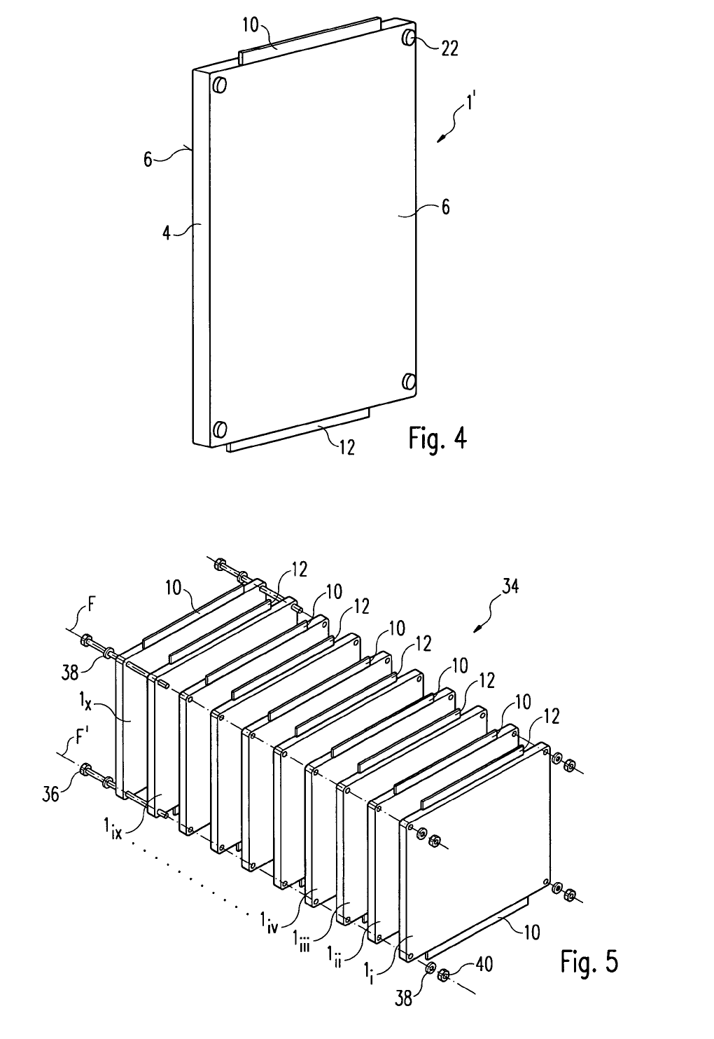

FIG. 5 a perspective exploded view of individual parts and assemblies respectively of a cell block according to a third exemplary embodiment of the present invention;

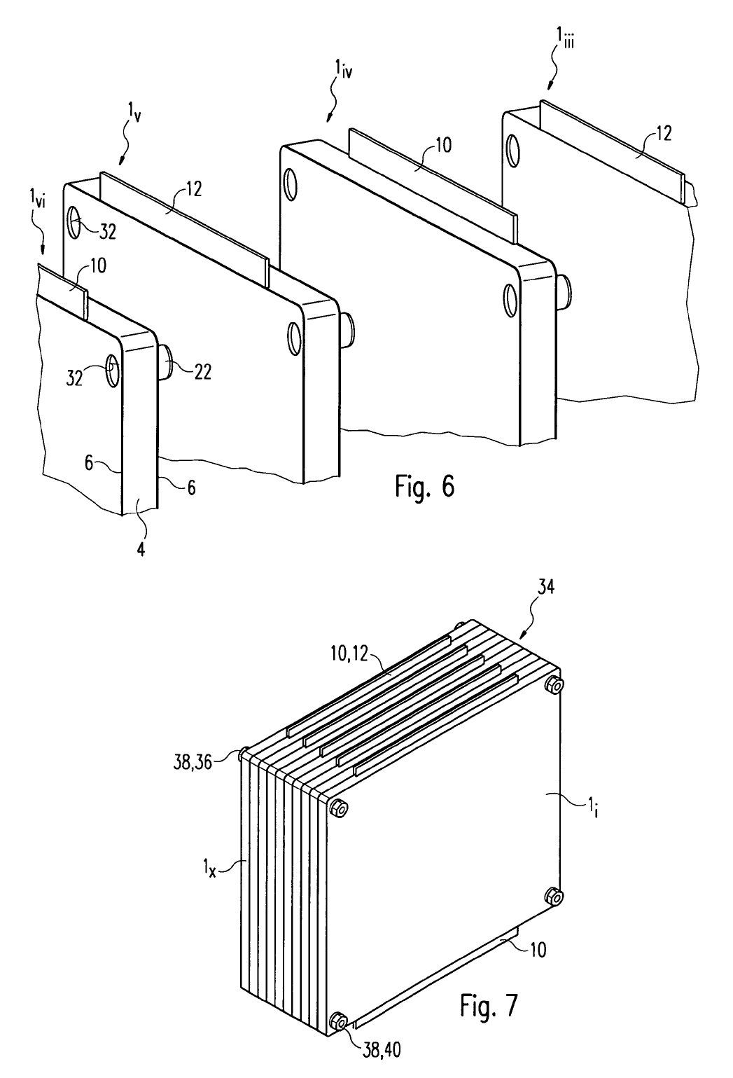

FIG. 6 an enlarged view of some assemblies of the cell block of FIG. 5 from another perspective;

FIG. 7 a perspective view of the cell block of FIG. 5 in the assembled condition;

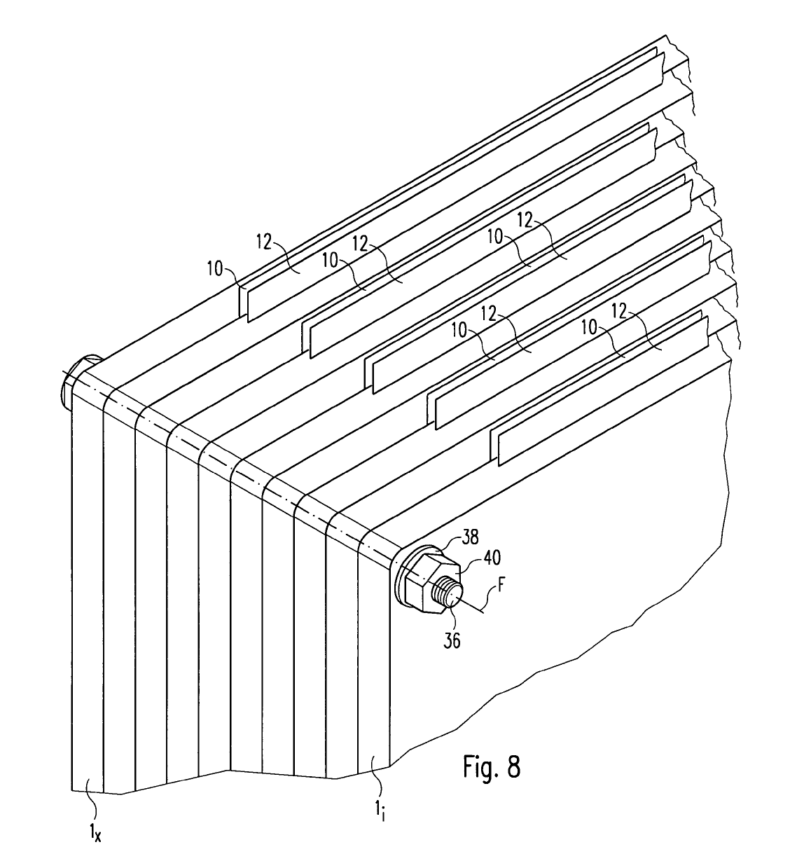

FIG. 8 an enlarged view of a detail VIII in FIG. 7;

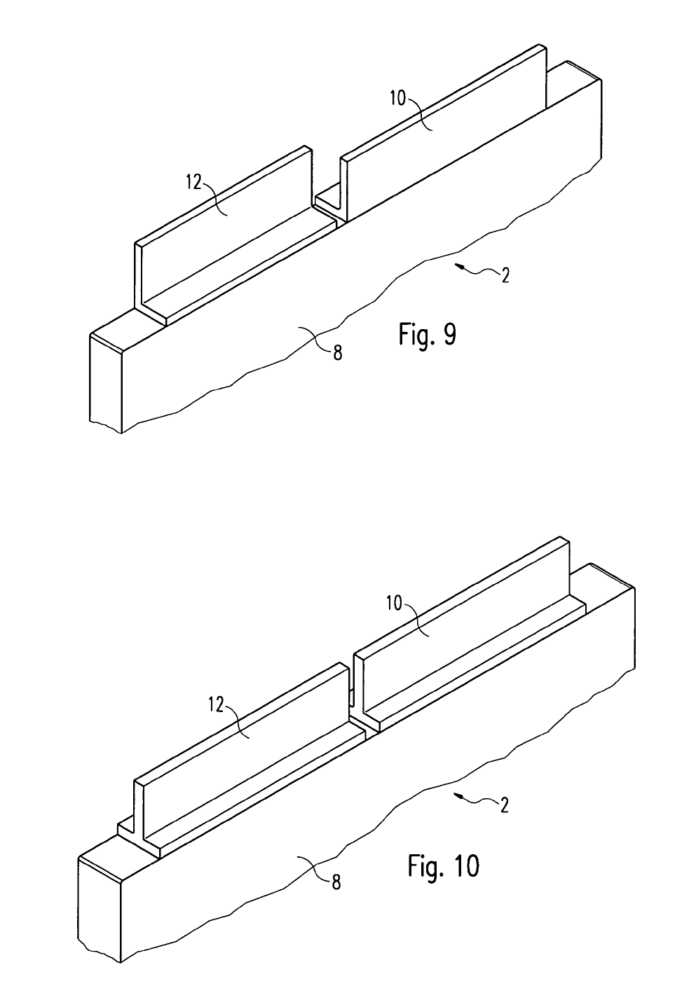

FIG. 9 an upper narrow face of a galvanic cell according to a fourth exemplary embodiment of the present invention in a perspective view;

FIG. 10 an upper narrow face of a galvanic cell according to a fifth exemplary embodiment of the present invention in a perspective view;

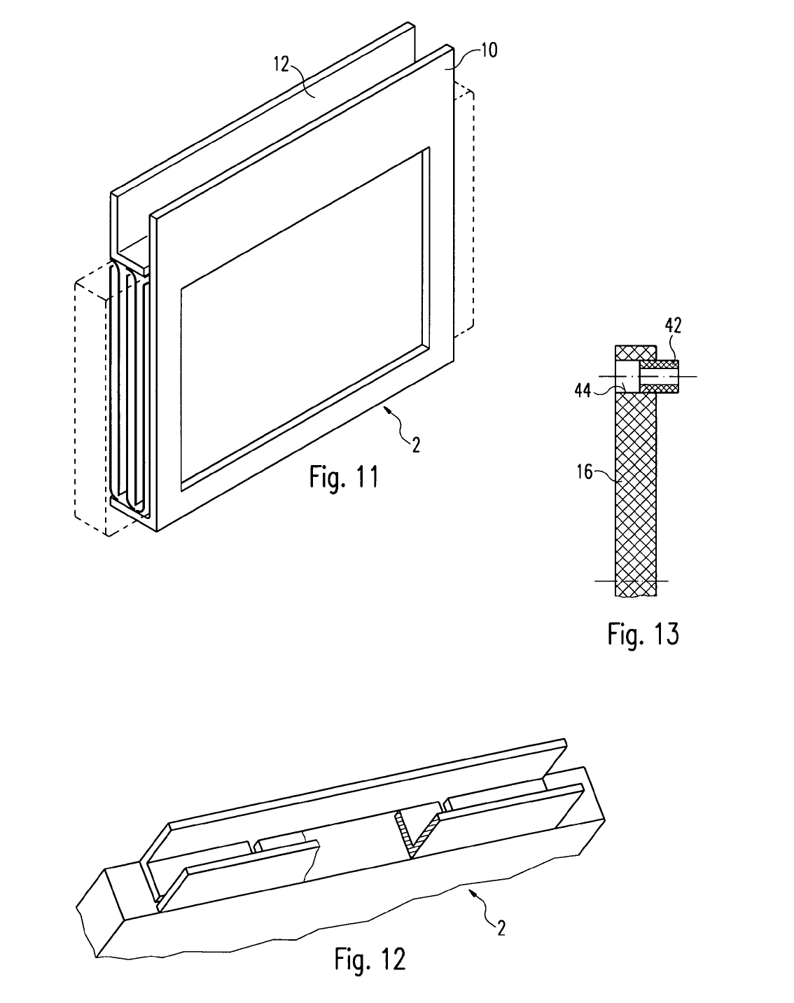

FIG. 11 a perspective view of an electronic module of a galvanic cell according to a sixth embodiment;

FIG. 12 an upper narrow face of a galvanic cell according to an eighth exemplary embodiment of the present invention in a perspective view;

FIG. 13 a section of a frame part in an eighth embodiment of the invention, wherein the representation corresponds to an upper part of the representation in FIG. 3; and

FIG. 14 shows a cell block according to the prior art.

It is pointed out that the representations in the Figures are schematic and restricted to the reproduction of the features most important for understanding the invention. It is also noted that the dimensions and proportions reproduced in the Figures and are solely chosen for clarity of illustration and to be understood as by no means limiting.

As an embodiment of the present invention a galvanic cell is described below with the aid of the representation in FIGS. 1 to 3. Of these, FIG. 1 is a perspective exploded view of individual parts and assemblies respectively of a galvanic cell 1, and FIG. 2a shows a section of a frame part along a plane II in FIG. 1, FIG. 2b shows a section of an active part along the plane II in FIG. 2, FIG. 3 shows a section of the frame part along a plane Ill in FIG. 1. The galvanic cell 1 is an electrical energy storage device in the sense of the invention.

According to the representation in FIG. 1 the galvanic cell 1 assembled from an electronic module 2, a frame part 4 and two cover foils 6, wherein the electronic module has a foil packet 8, an anode collector 10 and a cathode collector 12. For orientation purposes a set of coordinate axes is shown in the Figure, the origin of which is defined arbitrarily in the centre of the front cover foil 6. A lateral direction of the cell 1 is defined by the central axis in the x-direction A, a vertical axis of the cell 1 is defined by the central axis in the y direction B, and the axial direction of the cell, which is simultaneously the thickness direction of the cell, is defined by the central axis in the z-direction C. All axes are shown in thin dash-dotted lines. The positive direction is in each case represented by an arrow.

As can be seen in the Figure, the foil packet 8 has an essentially plate-like contour and the extension in the lateral direction (A) is greater than the extension in the vertical direction (B). The anode collector 10 is produced from a good conducting material and has an L-shaped cross-section. The short leg of the L-profile of the anode collector 10 is attached to the upper narrow face of the foil packet 8. Likewise the cathode collector 12 is produced from a good conducting material and has an L-shaped cross-section, and the short leg of the L-profile of the cathode collector is attached to the lower narrow face of the foil packet 8. The long leg of the anode collector therefore extends upwards (positive direction B) in alignment with the front flat face of the foil packet 8 and the long leg of the cathode collector 12 extends downwards (negative direction B) in alignment with the rear flat face of the foil packet 8. On the side facing away from the foil packet in the thickness direction the long legs of the L-profile of the anode collector and the cathode collector each carry a strip of a sealing foil 14 for connecting to the front or rear cover foil 6. It should be noted that the foil packet 8 forms an active part of the cell in the sense of the invention. The material for the current collectors 10, 12 is to be chosen from common materials such as copper, aluminum or other metals or alloys thereof. In order to improve the contact (reduction of the contact resistance) and/or to prevent corrosion, the current collectors 10, 12 can be silver- or gold-plated.

The frame part 4 has two vertical rods 16 and two horizontal rods 18, which form an integral frame. The internal contour of the frame is matched to the external contour of the foil packet 8. The upper horizontal rod 18 has a notch 20 with an L-shaped cross-section, which reduces in thickness on the inside and on the side directed towards the front cover foil 6 (positive direction C). The lower horizontal rod 18 has a notch 20, which reduces in thickness on the inside and on the side facing the rear cover foil (negative direction C). The shape of the notches is dimensioned such that it receives the L-profile of the anode collector 10 and of the cathode collector 12.

It should be noted that the frame part 4 is a seam part in the sense of the invention and those sections of the vertical rods 16 and the horizontal rods 18 of the frame part 4 which do not carry a notch 20, are sections of maximum thickness in the sense of the invention. The material of the frame part 4 is electrically non-conducting and has sufficient compressive rigidity that even under axial pressure (along the axis C), the sections of maximum thickness are still thicker than the electronic module 2 and the frame part 4 maintains its shape in a stable manner. Preferred materials are various plastics, ceramics and engineering glasses.

On the front flat face (positive direction C) the frame part 4 carries centring nipples 20 in the sections of maximum thickness, which are aligned with centring holes 24 in the cover foils 6. For clarification purposes, axes F, F′ of the centring nipples 22 and centring holes 24 are shown in the Figure on the left-hand side of the cell 1 (negative direction A). In FIGS. 2A and 2B the frame part 4 and the electronic module 2 respectively are shown in section along a plane II, which is defined by the axes B and C (perpendicular central plane in the axial direction). As shown, in its sections of maximum thickness the frame part 4 has a thickness T which is greater than a thickness t of the electronic module 2, in particular of the foil packet 8 of the same. In FIG. 2B the structure in the region of the foil packet 8 is shown in schematic form such that current collector foils of an anode side (anode conductor foils) 26 are connected to the anode collector 10 and arranged alternately with current collector foils of a cathode side (cathode conductor foils) 28, which are in turn connected to the cathode collector 12. Interposed foils of a chemically active material of the anode and cathode side, and separator foils within the foil stack 8 are omitted in the Figure for clarity.

FIG. 3 shows a section of the frame part 4 along a plane Ill in FIG. 1, which lies parallel to the plane II and extends through the two left-hand centring holes 24 and centring nipples 22 (see axes F, F′, E in FIG. 1). The section extends by definition through the left-hand vertical rod 16 of the frame part 4, wherein however an upper and lower region could also be arbitrarily assigned to the respective horizontal rod 18. As is clear, in each case a through hole 30 extends in alignment with the centring nipples 22 and on the flat face of the frame part 4 opposite to the centring nipples 22 an indentation 32 is provided which is dimensioned so that it could receive the centring nipple 22.

To assemble the cell 1 (cf. FIG. 1) the electronic module 2 is inserted into the frame part 4 such that the L-profiles of the anode collector 10 and the cathode collector 12 are seated in the notches 20 of the frame part 4. It is clearly visible that for this purpose the electronic module 2 and the frame part 4 must firstly be tilted towards each other, in order for example to move the cathode collector 12 through the opening of the frame part 4. As soon as the electronic module 2 has been inserted into the frame part 14, the front cover foil 6 is placed on this with the centring holes 24 on the centring nipples 22 of the frame part 4 in alignment and tightly connected, perhaps by means of suitable adhesives, welding or other adhesion methods. The strip of sealing foil 14 on the anode collector 10 then serves to form a connection between the anode collector 10 and the cover foil 6. Finally the rear cover foil 6 is placed onto the rear flat face of the frame part 4, wherein the centring holes 24 are aligned with the indentations 32 and connected in the same manner as the front cover foil 6 to the frame part 4 and the cathode collector 12.

FIG. 4 shows a perspective view of a galvanic cell 1′ according to a second embodiment of the present invention in the assembled condition. The galvanic cell 1′ of the second embodiment is identical in construction to the above described cell 1 of the first embodiment with the difference that the current collectors 10, 12 extend out of the shorter narrow faces of the cell 1′ instead of the longer narrow faces.

As a third embodiment of the present invention a cell block 32 is described below with the aid of the illustration in FIGS. 5 to 8. Of these FIG. 5 a perspective exploded view of individual parts and assemblies respectively of the cell block 34, FIG. 6 is an enlarged view of some assemblies of the cell block 34 from another perspective, FIG. 7 is a perspective view of the cell block 34 in the assembled condition, and FIG. 8 is an enlarged view of a detail VIII in FIG. 7.

As shown in FIG. 5, the cell block 34 is assembled from ten individual galvanic cells 1ᵢ to 1ₓ of the first embodiment, four screws 36, eight washers 38 and four nuts 40. Each even-numbered cell lᵢᵢ, lₓ is arranged according to the illustration in FIG. 1. That is, in the case of the even-numbered cells 1ᵢᵢ to lₓ the anode collector 10 is located at the top of the drawing and on the side facing the observer, while the cathode collector 12 is located in the cell block at the bottom and on the side facing away from the observer (in the drawing the lower cathode collectors of the even-numbered cells 1ᵢᵢ, . . . 1ₓ are hidden by cells in front of them). By contrast, the odd-numbered cells 1ᵢ, . . . 1ₓ are arranged in an orientation that is rotated relative to the illustration in FIG. 1 by 180° about the axis C. That is, in the case of these cells the cathode collector 12 is located in the cell block at the top and on the side of the cells facing away from the observer, while the anode collector 10 is located at the bottom of the cell block and on the side of the cells facing the observer. As a result, in each case one cathode collector 12 of an odd-numbered cell, e.g. the cell 1ᵢ, is located directly opposite an anode collector 10 of the next even-numbered cell, in the selected example therefore the cell 1ᵢᵢ, which is adjacent in the stacking direction. Between this cathode collector 10 of the even-numbered cell 1ᵢᵢ and the cathode collector 12 of the next odd-numbered cell, here therefore the cell 1ᵢᵢᵢ, a gap of approximately the thickness of two frame parts 4 is formed. The cathode collector 12 of the even-numbered cell 1ᵢᵢ lies directly opposite the anode collector of the next odd-numbered cell, here therefore the cell 1ᵢᵢᵢ, on the underside of the cell block in the stacking direction. Again, between this anode collector 10 of the odd-numbered cell 1ᵢᵢᵢ and the cathode collector 10 of the next even-numbered cell 1ᵢᵥ, a gap of approximately the thickness of two frame parts 4 is formed. This is continued up to the last cells 1ᵢₓ, 1ₓ. In other words, in the direction of increasing ordinal number of the cells, 1ᵢ, . . . , 1ₓ in the stacking direction one cathode collector 12 and one anode collector 10 lie directly opposite each other, while between this anode collector 10 and the next cathode collector 12 a noticeable gap is formed. It remains to be pointed out that in the case of the first cell 1ᵢ the anode collector 10 is accessible at the front face of the stack 34, while in the case of the last cell 1ₓ the cathode collector 12 is accessible at the rear face of the cell stack 34.

As is also clear, the screws 36 extend through the through holes 30 of the frame parts 4 and the through holes 24 of the cover foils 6 of the individual cells 1 (see for example the axes F, F′ in FIG. 5) and are secured with nuts 40 via washers 38.

Although the present invention has been described above in its essential features by reference to specific exemplary embodiments, it is understood that the invention is not restricted to these exemplary embodiments, but can be varied within the scope and range defined by the claims.

Thus, for example, the cells in the cell block 34 of the third embodiment are clamped by means of screws, washers and nuts. It is understood that this type of fixing is only exemplary and, for example, a rivet fixing, possibly using suitable pressure plates, is also possible. Where an easy disassembly of the cell stack 34 is desired, a screw fixing is advantageous, while in applications in which the connection or clamping must under no circumstances become detached, a non-detachable connection such as the riveting described above, can be preferred.

The clamping of the cell stack by means of clamping elements, which extend through holes in the frame-shaped sealing seams of the cells 1, is likewise only to be regarded as exemplary. Clamping can also be achieved by means of externally applied clips or sleeves.

The shape of the frame parts 4 shown in FIG. 1 is also only an example. Essential for the functioning of the present invention is the fact that the sealing seam of the one pouch-cell is constructed in the shape of a frame, surrounds the active part of the cell and, at least at points at which external axial pressure is to be expected on the cell, is thicker than the active part itself.

The structure and shape of the electronic module 2, that is of the electrode packet 8 and the collectors 10, 12 in FIGS. 1, 2B is only an example and can be adapted to the requirements. The collectors 10, 12 can also have a different profile, and the number of electrodes 26, 28 is completely open. Examples of variations with regard to the current collectors 10, 12 are shown in FIGS. 9 to 12. Thus the position of the collectors 10, 12 can be varied according to requirements. It is conceivable, for example, to accommodate both collectors 10, 12 on one of the narrow faces of the cell, as is shown for example in FIG. 9 or in FIG. 10. This has the advantage that the cells can be mounted with the underside, without the collectors suffering damage. In a cell of a fourth embodiment, according to the illustration in FIG. 9 the anode collector and the cathode collector 12 are arranged on opposing flat faces of the cell, while in a cell of a fifth embodiment according to the illustration in FIG. 10, they are aligned with one another in the centre of the upper narrow face. The interconnection can then be effected via suitably constructed contact clips.

A sixth embodiment is illustrated in FIG. 11. There also, both collectors 10, 12 extend with their free ends along a narrow face of the electronic module 2, but over the entire width and aligned with opposing flat faces. In this arrangement one of the collectors (here the anode collector 10) surrounds the whole foil stack 8. The arrangement according to this embodiment has the advantage that by arranging the cells in a stack in alternate senses, a series connection with directly adjacent current collectors can be implemented.

In a seventh embodiment according to the illustration in FIG. 12 the wiring arrangement as in the previous embodiment is also possible, although surrounding of the foil stack 8 by one of the current collectors 10, 12 is not available. In this embodiment two current collectors 10, 12 with an L-shaped cross-section are arranged on the same narrow face of the foil stack 8, wherein respective parts of the leg of the L-profiles of the collectors 10, 12 facing the foil stack 8 are notched in an interlocking toothed manner. It should be pointed out that the anode collector 10 in the Figure is only shown with a cut-away to clarify the profile cross-section. In actual fact the anode collector 10 is also a continuous profile piece.

An eighth embodiment is shown in FIG. 13. The illustration corresponds to that in FIG. 3, but only the top half of the frame part 4 is shown. In this embodiment, instead of the centring nipples 22 centring sleeves 42 are provided, which are inserted into holes 44. The centring sleeves 42 assume the function of the centring nipples 22 and the through hole 30 of the first embodiment (cf. FIG. 3), and the holes 44, in addition to receiving the centring sleeves 42, assume the role of the indentations 32 of the first embodiment. Where the cells 1 are clamped via separate through holes or even via externally placed elements, centring pins can also be used instead of sleeves (not shown in detail).

The fourth to eighth embodiments form variations of the first or second embodiment. The explanations with regard to the first or second embodiment are, where not excluded by the variation, applicable without exception to the fourth to eighth embodiments.

The present invention is suited to all types of storage cells for storing and discharging electrical energy, in particular electrochemical primary and secondary cells of any given type. Particularly preferably the invention is to be used with lithium-ion cells of flat construction and cell blocks assembled therefrom.

A cell block according to the above description, together with connection poles which are connected to the free current collectors 10, 12 of the first or last cell 1ᵢ, 1ₓ, and an optional housing, forms a battery or an accumulator which can be used in a vehicle or in other technical applications for supplying an on-board grid or for an electrical drive. Such a battery or accumulator is an electrical energy storage device in the sense of the invention.

### LIST OF REFERENCE LABELS

1, 1′ galvanic cell
2 electronic module
4 frame part (seam part)
6 cover foil (foil part)
8 foil packet (active part)
10 anode collector
12 cathode collector
14 sealing foil
16 vertical rod
18 horizontal rod
20 notch
22 centring nipple
24 centring hole
26 anode conductor foil
28 cathode conductor foil
30 through hole
32 indentation
34 cell block
36 cylindrical bolt
38 washer
40 nut
42 centring sleeve
44 through bore
101 (prior art: cell stack)
102 (prior art: cell)
103 (prior art: contact lug)
105 (prior art: baseplate)
A central axis in x-direction (prior art: anode)
B central axis in y-direction
C horizontal central axis in longitudinal (z) direction
D, D′ horizontal axes in lateral direction through 24
E vertical axis through 24
F, F′ horizontal axes in longitudinal direction through 22, 24
i, . . . , x index for 1
II plane B-C
III plane E-F/F′
K (prior art: cathode)
t thickness over all from 2
t thickness over all from 4

It is expressly pointed out that the above list of reference labels is an integral part of the description.

1.-35. (canceled)

36. An electric energy storage cell, having
an active part, which is designed and adapted to store electric energy supplied externally and to release stored electric energy to the exterior;
at least two current collectors that are connected to the active part and are designed and adapted to supply electric current externally to the active part and to release electric current released by the active part to the exterior, and
an enclosure, which describes a prismatic basic shape having a substantially cuboid-like outline and encloses the active part in a gas-tight and fluid-tight manner, wherein the extension of the prismatic basic shape of the cell in the thickness direction is substantially smaller than the extension in the two remaining spatial directions, wherein the extension in one of the two remaining spatial directions is greater than in the other of the two remaining spatial directions, and wherein the enclosure has two laminar foil parts and a peripheral seam part connecting the edges of the foil parts,
wherein the seam part surrounds the active part in the manner of a frame and has sections of maximum thickness, in which the thickness is uniformly greater than the thickness of the active part even under mechanical pressure, and
wherein at least in the sections of maximum thickness, the two foil parts rest on opposing flat faces of the seam part in a laminar manner and are connected tightly thereto,
wherein the seam part has through holes in sections of maximum thickness extending in the thickness direction and the foil parts have holes aligned with the through holes.

37. The electrical energy storage device according to claim 36, further comprising sleeves which extend into the through holes over part of the length of these and which project from one side of the seam part, wherein the excess length of the sleeves and the remaining free length in the through holes are greater than twice the thickness of the foils and less than half the maximum thickness of the seam part plus the thickness of the foils.

38. The electric energy storage cell according to claim 36, wherein the seam part has elevations projecting in the thickness direction, wherein on the respectively opposite side of an elevation an indentation is provided that matches the elevation in shape and size and is aligned therewith in the thickness direction, and the foil parts with the elevations or indentations have aligned holes of corresponding shape and extension, wherein the height of the elevations and the depth of the indentations are greater than twice the thickness of the foils and less than half the maximum thickness of the seam part plus the thickness of the foils.

39. The electrical energy storage device according to claim 38, wherein the through holes are centrally aligned with the elevations.

40. The electric energy storage cell according to claim 39, wherein the current collectors each have a flat profile and project beyond the enclosure.

41. The electric energy storage cell according to claim 40, wherein the current collectors project parallel to the flat faces of the basic prismatic shape defined by the enclosure.

42. The electric energy storage cell according to claim 41, wherein the current collectors extend along and bound opposing flat faces of the basic prismatic shape defined by the enclosure.

43. The electrical energy storage device according to claim 42, wherein the current collectors project from opposing narrow faces of the basic prismatic shape defined by the enclosure.

44. The electrical energy storage device according to claim 43, wherein the current collectors each extend between the seam part and one of the foils, and are connected tightly thereto.

45. The electric energy storage cell according to claim 44, wherein the seam part has notches matched in size and shape to the current collectors.

46. The electric energy storage cell according to claim 45, wherein the active part is evacuated.

47. A cell block, consisting of a plurality of electrical energy storage cells according to claim 36, wherein the cells are stacked in the direction of their thickness and rest on top of one another, at least in regions which correspond to the regions of maximum thickness of the seam part.

48. The cell block according to claim 47, wherein the cells are clamped together under pressure in the stacking direction, wherein the cells are clamped by means of tensioning rods which extend through the through holes of all cells.

49. An electrical energy storage device, comprising the cell block according to claim 48 and a first pole which is connected to a free current collector of the first electrical energy storage cell, and a second pole, which is connected to a free current collector of the last of the electrical energy storage cells.

50. A vehicle having the electrical energy storage device according to claim 49.
